(19) United States
(12) Patent Application Publication
(10) Pub. No.: US 2016/0017918 A1
(43) Pub. Date: Jan. 21, 2016

(54) BALL SEPARATOR FOR BALL BEARING ASSEMBLY

(71) Applicant: Hamilton Sundstrand Corporation, Windsor Locks, CT (US)

(72) Inventor: Thomas G. Corley, Windsor Locks, CT (US)

(21) Appl. No.: 14/332,513

(22) Filed: Jul. 16, 2014

(51) Int. Cl. F16C 33/37; F16C 33/66

(52) U.S. Cl. CPC F16C 33/3706; F16C 33/6681

(57) ABSTRACT

A ball bearing assembly including a plurality of ball bearings and one or more ball separators. Each of the ball separators comprises two pockets, each pocket including a contact surface formed having a shape complementary to the shape of the ball bearings, with one or more lubrication channels formed therein. The pockets also include a secondary surface formed to maintain a gap between one of the ball bearings and the secondary surface when arranged in the circular groove. The presence of the lubrication channels enhances lubrication and reduces the contact area between the ball separators and the ball bearings.

### BACKGROUND

The present disclosure relates generally to ball separators for mounting ball bearings and, more particularly, to an improved ball separator for mounting a plurality of ball bearings in series, for example, within a propeller hub.

Propeller hubs include a plurality of openings which each receive a propeller blade. A typical way of mounting a blade within the hub is the use of a row of ball bearings mounted into mating grooves in the hub and the blade. Typically, an opening in the hub allows the passage of the ball bearings into the mating grooves. The blade is then locked in place with some form of lock or support ring. One type of such assembly known in the art utilizes a length of ball separator material, sometimes called a necklace, to separate and mount a plurality of ball bearings. The ball bearings can then be inserted into the groove through the opening in the hub, and as a row with the length of the ball separator. The ball separator includes links connecting adjacent ball separator pockets. The balls sit between these pockets. The ball separators in the prior art have had pockets that closely match the ball bearing's outer surface across the entire portion of the ball separator. This arrangement results in relatively high friction between the ball separators and the ball since it is over such a large area.

Current solutions to this problem include ball separators with pockets having multiple radii, such that one surface is in contact with the ball bearings and another surface is closely spaced from the ball bearing. Typically, a first, more central surface is closely matched to the outer periphery of the ball bearing, and provides guidance and support for the ball bearing. A second surface, which surrounds the first surface, is spaced slightly further from the ball bearing. This second surface will prevent the ball bearing from falling outwardly of the ball separator or series of ball separators when being arranged in the propeller hub.

The performance and reliability of such ball bearing assemblies and associated ball separators can potentially reduce maintenance costs and increase the life of the rotating parts of the overall apparatus. Accordingly, the industry remains receptive to improvements in ball separators and ball bearing assemblies.

### SUMMARY

Disclosed herein is a ball separator for a ball bearing assembly characterized by a body having two pockets formed on opposing sides thereof. At least one of the pockets includes a contact surface defined by a first radius from a centerpoint, the first centerpoint lying outside the ball separator. The contact surface of the pocket has one or more lubrication channels formed therein. The pocket further includes a secondary surface characterized by a distance from the centerpoint that is greater than the first radius.

Another aspect of the disclosure provides a ball bearing assembly including a plurality of ball bearings and one or more ball separators. Each of the ball separators comprises two pockets, each pocket including a contact surface formed having a shape complementary to the shape of the ball bearings, with one or more lubrication channels formed therein. The pockets also include a secondary surface formed to maintain a gap between one of the ball bearings and the secondary surface when arranged in the circular groove.

### BRIEF DESCRIPTION OF THE DRAWINGS

The following descriptions should not be considered limiting in any way. With reference to the accompanying drawings, like elements are numbered alike:

FIG. 1 is an illustration of a ball separator according to another embodiment;

FIGS. 2A and 2B are a front views of a ball separator according to alternative embodiments; and

FIGS. 3A and 3B are cross-sectional views of the ball separators depicted in FIG. 2A and 2B, along lines A-A and B-B, respectively;

FIG. 4 is an illustration of a ball bearing assembly according to one embodiment;

FIG. 5 is a front elevation view of the ball bearing assembly depicted in FIG. 4;

FIG. 6 is a sectioned top view of the ball bearing assembly depicted in FIGS. 4 and 5, along line C-C of FIG. 5;

FIG. 7 is a partial view of a rotor hub and blade employing a ball bearing assembly and according to another embodiment;

FIG. 8 is a cross-sectional view of a ball bearing assembly being assembled in a rotor hub according to another embodiment;

FIG. 9 is an illustration of a ball bearing assembly according to another embodiment;

FIG. 10 is an illustration of a ball separator linkage of a ball bearing assembly according to another embodiment; and

FIG. 11 is a front view of a ball separator for a ball separator linkage according to another embodiment.

### DETAILED DESCRIPTION

A detailed description of one or more embodiments of the disclosed apparatus and method are presented herein by way of exemplification and not limitation with reference to the Figures. It is to be understood that other embodiments may be utilized and changes may be made without departing from the scope of the present disclosure.

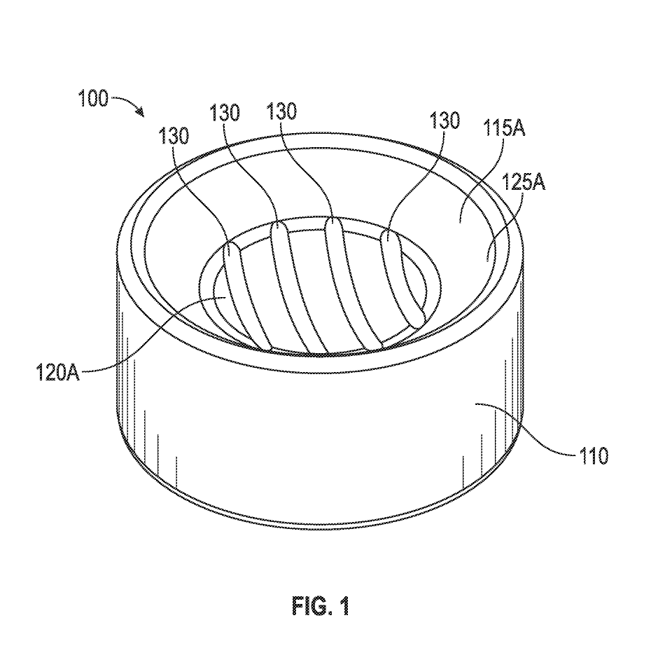

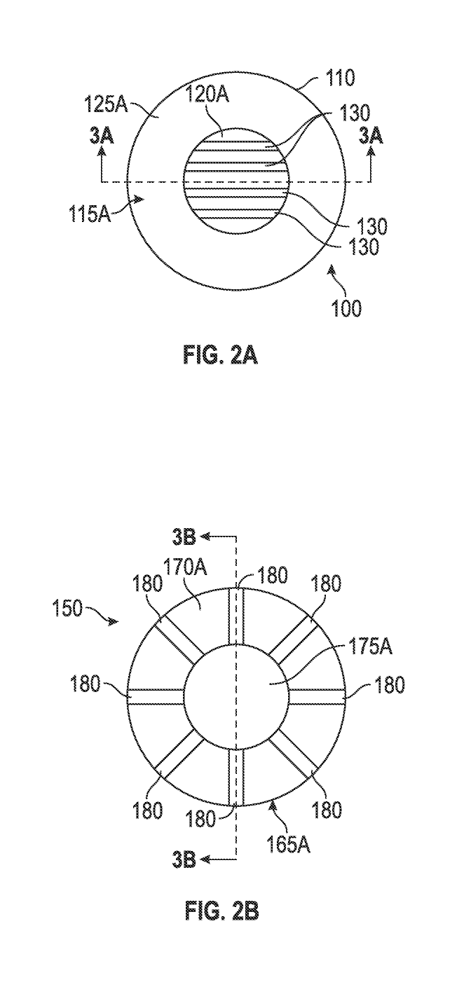

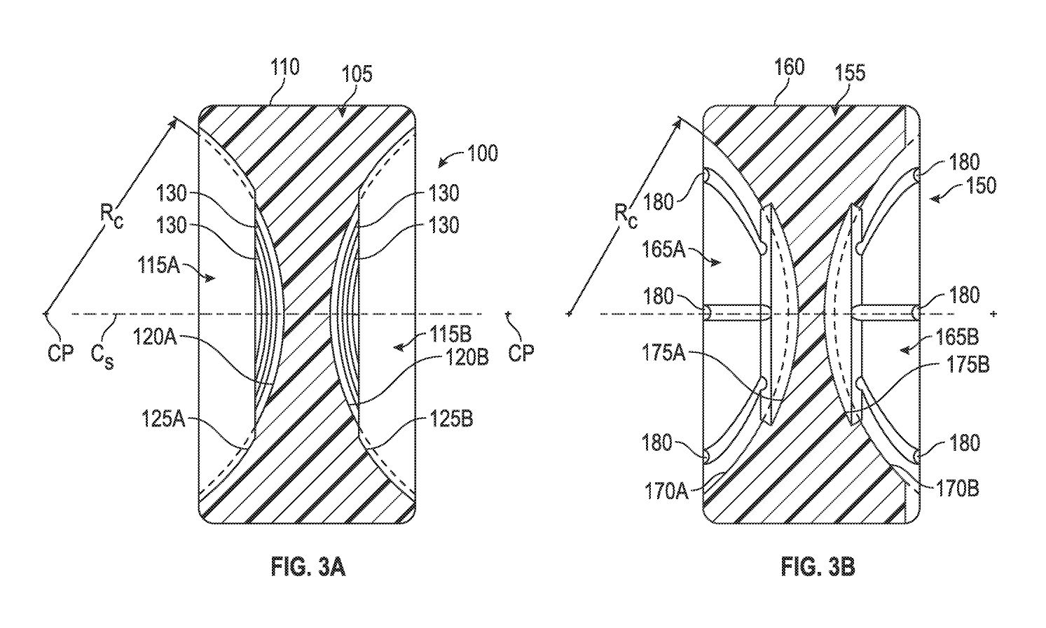

The disclosure provides various examples of a ball separator for a ball bearing assembly. FIG. 1 is a perspective view of a ball separator 100 according to one example of the present disclosure. FIG. 2A is a front view of the ball separator 100 of FIG. 1 and FIG. 3A is a cross-sectional view along line B-B of FIG. 2A. As shown in FIGS. 1, 2A, and 3A, the ball separator 100 includes a body 105 defined by an outer surface 110, with a first pocket 115A formed on one side of the body 105 and a second pocket 115B formed on another side of the body 105 opposite the first pocket 115A. In the illustrated embodiment the outer surface 110 is substantially cylindrical in shape, but the outer surface may be spherical, rectangular or any other shape.

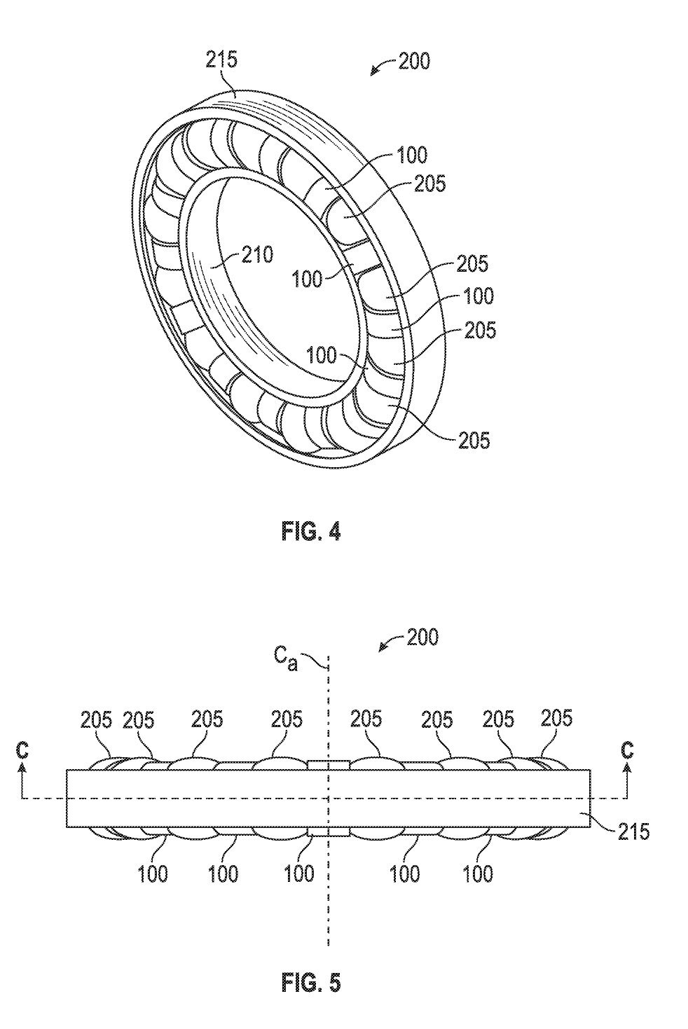

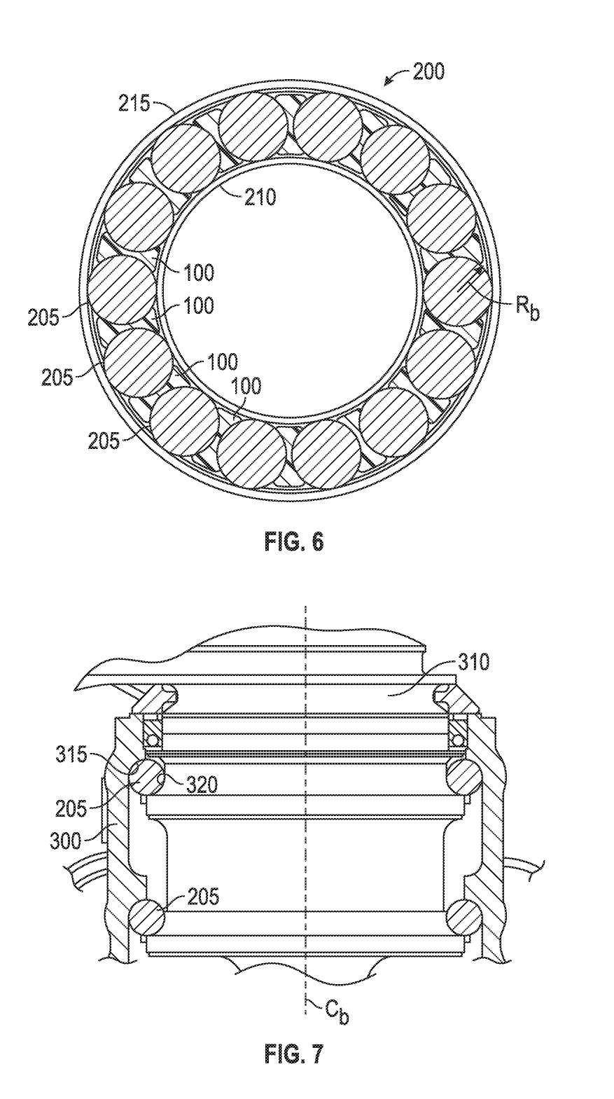

The two pockets 115A and 115B are formed to receive a ball 205, (see FIG. 4, et seq.) and are typically concave in shape. In the embodiment illustrated in FIGS. 1, 2A, and 3A, the pockets 115A and 115B (See FIG. 3A) arranged generally coaxially about a central axis Cₛ of the ball separator 100. Each of the pockets 115A and 115B includes multiple surfaces or regions including a contact surface 120 and one or more secondary surfaces 125. In FIGS. 1, 2A, and 3A, the contact surfaces 120A, 120B are formed about the central axis A of the ball separator 100 with the secondary surfaces 125A, 125B arranged radially outward and directly adjacent to the corresponding contact surface. The contact surfaces 120A, 120B are formed having a shape that is complementary to a ball 205 (See, e.g., FIG. 6), such that the contact surfaces 120A, 120B may be in continuous or substantially continuous contact with the surface of the respective ball.

The ball separator 100 of the present disclosure include contact surfaces 120A, 120B that comprise one or more lubrication channels 130, which are formed as grooves or depressions in the contact surfaces 120A, 120B. The lubrication channels 130 should be formed having sufficient size and shape to introduce a lubricant into the interface between the contact surfaces 120A, 120B and the balls 205. In addition, the presence of the lubrication channels 130 may reduce the area of the contact surfaces 120A, 120B, further reducing the amount of friction. In one example, where parallel lubrication channels 130 were formed in the contact surfaces 120A, 120B, (similar to FIG. 2A), having a depth and width of approximately 0.010 to 0.025 inches, the contact area is reduced by 10-20%. The lubrication channels 130 may be formed as parallel grooves, radial grooves, or any other configuration of isolated or connected channels, (see, e.g., FIG. 11). The lubrication channels 130 may have any suitable profile, but may be square with a rounded bevel to minimize local stresses. The profile and configuration of the lubrication channels 130 may also be chosen for ease of manufacturing.

The secondary surfaces 125A, 125B may be formed to maintain a gap of constant or varying distance between the balls 205 and the respective secondary surface. For example, where the contact surfaces 120A, 120B are formed having a shape, radius R_{b} of the balls 205, (see FIG. 6), measured from a centerpoint CP lying outside the body 105, the secondary surfaces 125A, 125B may be characterized by a distance from the centerpoint that is greater than the radius defining the contact surfaces 120A, 120B. This includes any shape that lies outside of the radius R_{b}, extending from the centerpoint, such as an inverted partial spheroid having the same radius but formed about a second centerpoint that lies closer to the body 105 of the ball separator 100. In the embodiment of FIGS. 1, 2A, and 3A, the pockets 115A and 115B is formed to have a small gap between the secondary surfaces 125A, 125B and the balls 205, whereby the secondary surfaces 125A, 125B may provide support to the balls 205 and prevent separation during assembly.

Additional arrangements of the contact surfaces and lubrication channels are numerous. For example, FIG. 2B is a front view, according to an alternative embodiment of a ball separator 150, and FIG. 3B is a cross-sectional view along line C-C of FIG. 3B. The ball separator 150 comprises a body 155 and an outer surface 160, with two pockets 165A and 165B on opposite sides of the ball separator. In this embodiment, the contact surfaces 170A, 170B are formed radially outward from the secondary surfaces 175A, 175B. The ball separator 150 further comprises lubrication channels 180 that are arranged to span across the contact surface in a radial direction.

In the embodiment of FIGS. 2B and 3B, the secondary surfaces 175A, 175B may form shallow receptacles for the lubricant. The embodiment shown in FIGS. 2B and 3B may be further modified so that the secondary surfaces 175A, 175B comprise the inner walls of a passage through the ball separator 150, connecting to the other side. Even a small hole between pockets 165A and 165B would reduce the weight of the assembly and provide additional ways for lubricant to pass from one pocket to another.

FIGS. 4 to 6 illustrate a ball bearing assembly 200 according to another embodiment of the present disclosure. FIG. 4 is a perspective view of a portion of the ball bearing assembly 200, FIG. 5 is a front elevation view of a portion of the ball bearing assembly 200, and FIG. 6 is a cross-sectional view of a portion of the ball bearing assembly 200 taken along line A-A of FIG. 5. As shown in FIGS. 4-6, the ball bearing assembly 200 includes a plurality of balls 205 (i.e., ball bearings) positioned to operate in a generally circular groove (e.g., raceway, angled-groove, etc.), a plurality of ball separators 100, (as described above), an inner ring 210 and an outer ring 215. The ball bearing assembly 200 is arranged relative to a centerline Cₐ (FIG. 5). The balls 205 can each have a known spherical configuration, and may all have substantially the same radius R_{b} (FIG. 6). A rotational movement between the inner ring 210 and outer ring 215 can be achieved during operation through corresponding movement of the balls 205. The inner ring 210 and outer ring 215 may each comprise multiple elements, e.g., rings formed integral to another structure, races, angled features for self-alignment of the bearing assembly, etc. In the embodiment illustrated in FIGS. 4-6, one of the ball separators 100 is positioned between each pair of adjacent balls 205 to prevent ball-to-ball contact.

The ball separators 100 may be made of a low-friction polymer material, such as a material made up of approximately 85% by weight polytetrafluoroethylene (PTFE) and 15% by weight graphite, plus incidental impurities. Other known low-friction material can be utilized as desired. The balls 205 are able to rotate with minimal frictional interference from the ball separators 100. The ball separators 100 need not support any loads between the inner ring 210 and the outer ring 215, which load should be transferred by the balls 205.

FIG. 7 illustrates a rotor hub and blade mounting system employing a ball bearing assembly according to another embodiment. The hub 300 has an aperture 305 to receive a blade 310. As known, the hub 300 will actually rotate about an axis generally perpendicular to a central axis C_{b} of the blade 310. The blade 310 is mounted to the hub 300, and spaced circumferentially about the axis of rotation. As shown, a groove 315 in the hub 300 mates with a recess 320 in the blade 310, and receive balls 205. Alternatively, a plurality of blades may be mounted to one or more hubs.

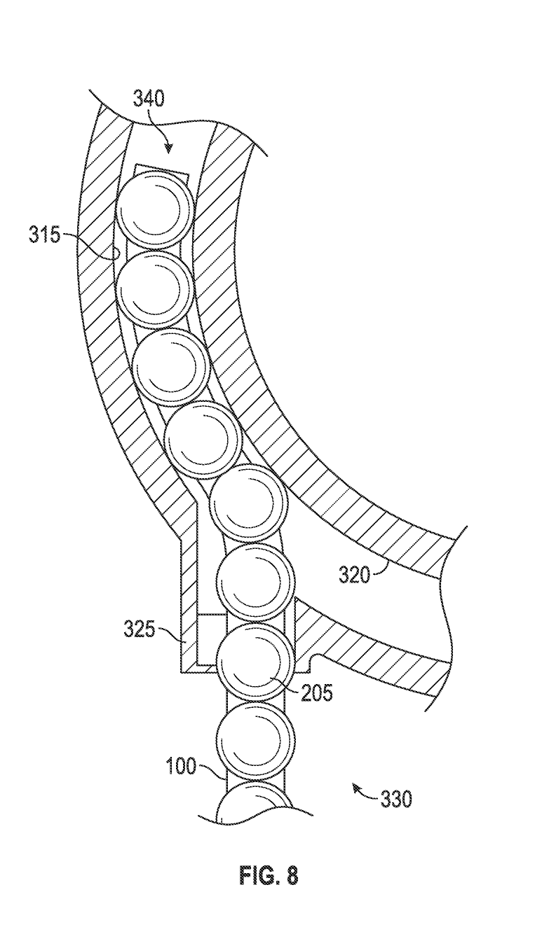

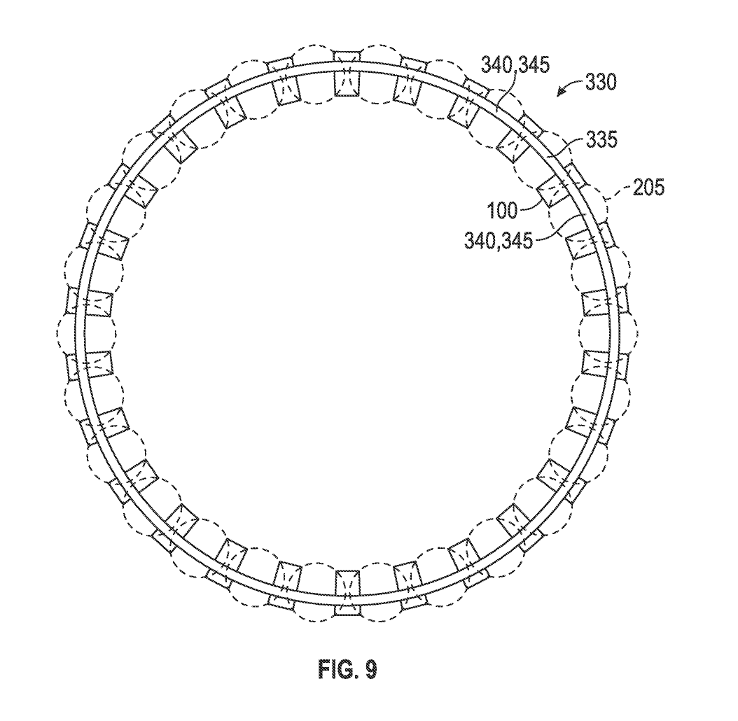

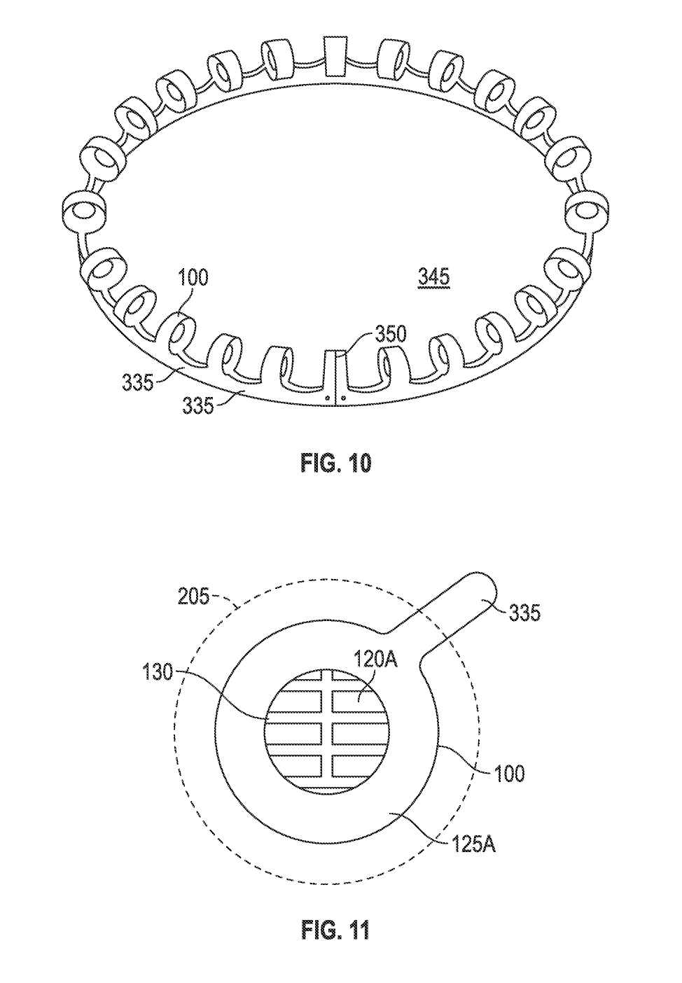

As shown in FIG. 8, the hub 300 may have opening 325 to receive a plurality of balls 205. The opening 325 within the hub 300 allow the balls 205 to be moved as an ball bearing linkage 330 into the groove 315. The ball bearing linkage 330 include a plurality of ball separators 100 that are linked by connecting element 335, (see FIG. 10), with the ball separators 100 arranged in between each of the plurality of balls 205. The ball bearing linkage 330 mounts all of the balls 205 as a single element, (see FIG. 9), and is sometimes called a necklace. As shown in FIG. 8, when the ball bearing linkage 330 is moved into the opening 325, it sometimes must bend into a reverse curve orientation. This orientation could cause the balls 205 to leave the ball bearing linkage 330 without the secondary surface being configured as a supporting surface, (see FIG. 2A).

FIGS. 9-11 depict the ball separators 100 according to one embodiment, linked together by one or more connecting element 335. FIG. 9 shows the ball bearing linkage 330 fully assembled, FIG. 10 shows a plurality of ball separators 100 arranged in a chain 340, and FIG. 11 shows a single ball separator 100 with an individual connecting element 335. As shown in FIG. 10, the ball separator 100 may be arranged with a single connecting element comprising a necklace 345, which can be brought into a circular arrangement by attaching the ends of the necklace 345 at connection point 350. Alternatively, each one of the ball separator 100 may be formed with an individual connecting element 335, (see FIG. 11), that is connected to the connecting element 335 of other ball separators 100 in a chain. FIG. 11 shows one of the ball separators 100 having an arrangement of lubrication channels 130 that are connected, as described above.

It will be appreciated the present invention provides numerous advantages and benefits. For example, the present invention helps reduce undesired effects from bunching of balls in bearing assemblies that has been discovered to occur in certain applications due to cyclic loading. The present invention also provides ball separators 100 that have a relatively low frictional impact on bearing assembly operation.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc., do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A ball separator for a ball bearing assembly, comprising:
a body having two pockets formed on opposing sides thereof, at least one of the pockets comprising:
a contact surface defined by a first radius from a centerpoint, the first centerpoint lying outside the ball separator, the contact surface shaped to contact a ball bearing and having one or more lubrication channels formed therein; and
a secondary surface separated by a distance from the centerpoint that is greater than the first radius.

2. The ball separator of claim 1, further comprising a connecting link.

3. The ball separator of claim 2, the connecting link extending from an outer surface of the body.

4. The ball separator of claim 1, wherein the one or more lubrication channels comprise a plurality of lubrication channels formed in parallel.

5. The ball separator of claim 1, wherein the one or more lubrication channels comprise a plurality of lubrication channels, two or more of the plurality of lubrication channels being connected.

6. The ball separator of claim 1, wherein the contact surface is surrounded by the secondary surface.

7. A ball bearing assembly, comprising:
a plurality of ball bearings; and
one or more ball separators, each of the ball separators comprising two pockets, at least one of the pockets comprising:
a contact surface formed having a shape complementary to the shape of the ball bearings, the contact surface contacting one of the ball bearings and having one or more lubrication channels formed therein; and
a secondary surface formed to maintain a gap between one of the ball bearings and the secondary surface when arranged in a circular groove.

8. The assembly of claim 7, wherein the contact surface lies in the center of the at least one pocket.

9. The assembly of claim 8, wherein the ball separators are connected in series by one or more connecting elements.

10. (canceled)

11. The assembly of claim 7, wherein the one or more lubrication channels comprise a plurality of lubrication channels formed in parallel.

12. The assembly of claim 7, wherein the one or more lubrication channels comprise a plurality of lubrication channels, two or more of the plurality of lubrication channels being connected.

13. The assembly of claim 7, wherein the lubrication channels are in fluid communication with the secondary surface.

14. The ball separator of claim 1, wherein the secondary surface does not contact the ball bearing and the lubrication channels are in fluid communication with the secondary surface.
